(19) United States
(12) Patent Application Publication
(10) Pub. No.: US 2008/0097723 A1
(43) Pub. Date: Apr. 24, 2008

(54) Intelligent monitoring system and method for mill drives in mineral grinding processes

(75) Inventors: Jorge Antonio Pontt Olivares, Valparaiso (CL); Jaime Jose Rebolledo Campos, Valparaiso (CL); Esteban Marcelo Cid Gonzalez, Valparaiso (CL); Ricardo Antonio Araya Cereceda, Valparaiso (CL)

Correspondence Address: Eric A. Hanscom, Esq.;Law Offices of Eric Hanscom, 7395 Portage Way, Carlsbad, CA, 92011, US

(73) Assignee: UNIVERSIDAD TECNICA FEDERICO SANTA MARIA, Valparaiso (CL)

(21) Appl. No.: 11/900,415

(22) Filed: Sep. 10, 2007

(30) Foreign Application Priority Data
Sep. 11, 2006 (CL) CL 2390-2006

(51) Int. Cl. B02C 25/00

(52) U.S. Cl. 702/182; 241/36; 700/108

(57) ABSTRACT

The present invention refers to an intelligent monitoring system and method of a 12-pulse LCI drive that controls the motors in charge of driving SAG and ball mills present in the mineral grinding process. It includes a monitoring module which is able to efficiently determine the origin of certain types of failures, which allows solving the problem in a quick manner based on the topology knowledge of the 12-pulse LCI drive which is being monitored. The system and method also determines and identifies the overall operation state of the 12-pulse LCI drive by an inspection of the variables related with the control loop in a way to identify control adjustments malfunction as well as the inspection of the symmetric operation of the 6-pulse LCI drives which conform the 12-pulse LCI drive.

### FIELD OF THE INVENTION

The present invention consists of an intelligent monitoring system and method for driving a mineral grinding mill and more specifically, intelligent monitoring of a kind of converter named 12-pulse Load Commutated Inverter (LCI) which controls the motor in charge of driving the semi-autogenous (SAG) mills and steel balls present in the mineral grinding process.

### BACKGROUND OF THE INVENTION

Chile's most important natural resource, from the economical and business point of view, is copper. Chile has a large number of mines operating over 2000 meters above sea level which implies using expensive electrical and mechanical machinery. Since Chile is mainly an exploiter of natural resources, acquisition of expensive expert support is required in most cases of operational failure, which adds up to unavoidable losses due to partial or full production paralyzation.

Among the different processes carried out in copper mining one of the most important processes is fine mineral grinding. Minerals that come from the crushing stage enter the SAG mills and steel balls, which have the function of drastically reducing the size of the mineral, to proceed afterwards to the flotation process. In this process of fine grinding the most relevant equipment are the SAG mills and steel balls which are driven by huge synchronic motors (of up to 20 MW). These are controlled electrically by power converters, cycloconverters (CCV) or load-commutated inverters (LCIs) among others. Despite the electrical drive controls mill drive other monitoring systems are used additionally which register real-time variables of the mill, as well as of the electrical variables of the electrical drive. The objective of this monitoring is to have readings available of what is occurring and also register events that could happen, such as failures or non-scheduled stops, providing information for afterward analysis.

Among the most used solutions nowadays is the device “Transient Recorder” from the company ABB. This equipment determines if the electrical control functions properly by evaluating the monitoring of mechanical and electrical signals according to criteria and limits established by the manufacturer. This device has a rigid and closed composition and structure, that is to say, it is only compatible with other ABB equipment making it a nonflexible device. It does not allow for modifications according to drive requirements.

SIEMENS has a system called “Totally Integrated Automation (TIA)”, which allows the efficient automation of any industrial production process. It is not specific or an expert on electrical drives, additionally it is only based on proprietary software and hardware of SIEMENS.

Besides these commercial products there are patents directly or indirectly related to the monitoring of mill drives. Among those that directly relate with the proposed Monitoring System, is the U.S. Pat. No. 4,404,640, titled “Grinding mill monitoring instrumentation” of Robert F. Dumbeck and Phillip W. Welch, which describes an invention that monitors different operation conditions of a ball mill, displaying on a screen the mill operation and storing data to have a register. The instrumentation used for this case corresponds only to current transformers (CT) which are coupled to the motor feed. These transformers sense the current that flows through the motor and this measurement is employed to obtain the power developed by the mill. Besides this signal, the information of mineral flow through the mill is available with which the efficiency of the equipment is estimated and optimized.

Another related patent is U.S. Pat. No. 5,698,797 titled “Device for monitoring a ball grinder” of Daniel Fontanille and Jacques Barbot which describes the continuous monitoring of three parameters of the ball mill operation: a) quantity of mineral, b) amount of balls, c) wear of the armor plating inside the walls of the mill. To do this, the proposed device employs an electromagnetic wave emitter placed inside the mill and at least one electromagnetic wave receiver placed close to the mill. Using the angular placement of the receiver as well as other special electronic devices, it is capable of detecting the mentioned parameters of the ball mill operation.

The U.S. Pat. No. 6,874,366 titled “System to determinate and analyze the dynamic internal load in revolving mills, for mineral grinding” of Luis Magne, Waldo Valderrama, Jorge Pontt, Ennio Perelli, Claudia Velasquez and German Sepulveda (patent pending CL 189-03), describes a system as a method to measure in a direct, dynamical and online way different parameters related to the internal dynamic load of a mill when in operation. The system is basically composed of wireless acoustic sensors that are coupled to the mill, receivers and conditioning units that are located close to the mill and communication and processing units. The output signals of the system are transmitted to the central control system. The main objective of this invention is to increase the efficiency of the grinding process as well as the availability of the equipment. To achieve this, the total internal load of the mill (of both balls and mineral) is monitored moreover the apparent density of the mill's internal load.

Other patents related indirectly with the proposed invention are presented in the following sections. The U.S. Pat. No. 6,577,987 titled “Operational monitoring for a converter” of Guido Wenning describes a generic operational monitor. It bases itself on comparing a mean value with a stored reference value. According to the proposed method, al least two comparisons are needed (one considering the input signal and the other the output signal) which are contrasted to their respective references (with a certain tolerance). This generates a state signal for each comparison, which in turn are evaluated in a central evaluation unit to determine the operational state of the converter.

Other patents that are indirectly related to the proposed invention are the ones that reference mill control instead of mill monitoring. Although this difference is relevant, these patents contribute well to the conception of monitoring methods, given that to obtain control of the mill it is necessary to have a good monitoring system of its variables.

In this manner, the U.S. Pat. No. 4,611,763 titled “Method and apparatus for controlling a grinding mill” of Hiroshi Tomiyasu, Masahiro Hattori and Yoshio Itoh, describes an apparatus as a method to automatically control a mill, having as an objective the maximization of its efficiency. The system includes a grinding mill, a raw material feed apparatus and a controller, which receive signals from the mill and uses them as inputs, comparing them to its respective references. Based on this, the controller generates an output which is used as an input signal for the raw material feed apparatus. This signal is updated by an integrator which modifies the reference signal after a given time.

The U.S. Pat. No. 4,586,143 titled “Grinding mill control system” of Robert F. Dumbeck and Phillip W. Welch describes the capacity to process multiple signals that originate from a ball mill and the relationship among them. Analysis of variations of the flow of material through the mill generates control actions so that mill operates close to its optimum work point which is defined previously.

The proposed invention has a direct relationship with these kinds of monitoring and supervision systems. These systems are presently available in the market but only focused on monitoring how the electric system functions by registering electric variables. The new intelligent monitoring system for 12-pulse LCI drive used in mineral grinding mill, proposes a method and its implementation that offers a detailed monitoring with new functionalities that can be personalized according to specific needs. In this manner, it is possible to perform similar functions to the ones that exist in a conventional monitoring system. Additionally it is possible to identify a determined type of failures and infer the overall drive operation state of the mill based on a comparison of online measurements and theoretical behavior. As a result of this, there is a significant and clear difference and improvement with respect to the existing systems that are commercialized.

### BRIEF SUMMARY OF THE INVENTION

The present invention is an intelligent system and method for monitoring a 12-pulse LCI drive used in mineral grinding operation. Specifically this monitoring system corresponds to an electronic device that is ideally installed close to the electrical drive of a SAG or ball mill, which monitors its operation status.

This device as such is an industrial computer that incorporates hardware and software that is specialized in external signal acquisition and processing. The drive signals that are monitored are normally available from the same drive control, thus avoiding additional hardware for measuring (sensors). Nonetheless, along with the classic monitoring variables (input and output voltages and currents) the system requires signals that have the conduction state information for each semiconductor from 12-pulse LCI drive for the short-circuit surveillance. Thus, some applications may need to include some hardware associated to this requirement.

Concerning the method, this system includes an application specifically developed for this monitoring system. This method contemplates 4 main functions which may be adapted and personalized depending on the needs or applications in which the monitoring system is employed. These functions are:

A) Monitor and register abnormal operation conditions (failures) of a 12-pulse LCI drive.

B) Historical registry of some electrical variables of interest of a 12 pulse LCI drive.

C) Short-circuit detection in 12-pulse LCI drive operation.

Besides these functions, the system provides a visualization screen for the monitored variables, as well as storage on a hard drive. Configuration and system operation via Ethernet is also available.

When high power drives and electrical machinery are used in conjunction with mechanical equipment of big size, weight and inertia it is necessary to perform constant maintenance. This allows maintaining a high availability of the equipment and diminishes the probability of coming out of service (consequence of the large amount of potential failures that could present themselves due to the complexity of the system). Regardless of all the equipment maintenance, the probability of failure is not completely eliminated. Thus, one of the biggest problems is to identify these failures; its location and finally determine its origin and solution in a quick and effective manner. Taking into consideration the fact that the mining industry is developed at reasonably high altitudes of hard access, it is not feasible to have immediate assistance of the specialized technical support. All this makes the trustworthiness and availability of key production equipment one of the main objectives of planning. Thus the intelligent system and method for monitoring a 12-pulse LCI drive for mineral grinding has a main objective of providing a monitoring system with classical functions as well as innovative ones in such a way to supply more and better information on drive operation.

When incorporating intelligent monitoring it is possible to determine the origin of certain types of failures based on the knowledge of the 12-pulse LCI drive topology that is monitored.

In this manner a classical monitoring system is available but with a new functionality related with a efficient detection of a certain kind of failures associated with malfunction on semiconductors of a 12-pulse LCI drive which permits a quick solution for the problem.

### BRIEF DESCRIPTION OF THE DRAWINGS

FIG. 1 illustrates a power circuit of a 12-pulse Load Commutated Inverter (12-pulse LCI) which feeds a synchronic motor. This configuration is one of the most classically used for mineral grinding circuits (background art).

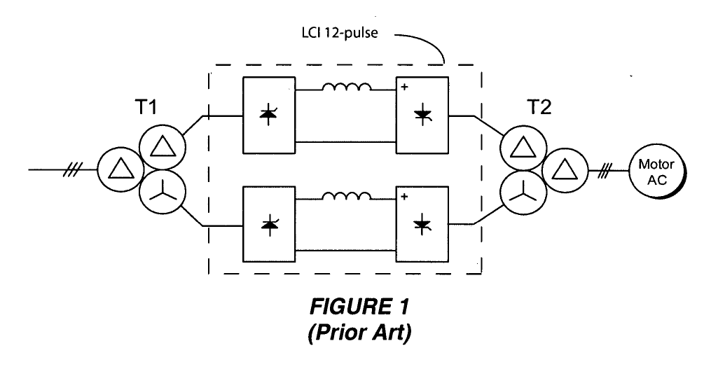

FIG. 2 illustrates a block diagram of an intelligent monitoring system in conjunction with the 12-pulse LCI drive control. This figure illustrates the interconnection between the intelligent monitoring system and the 12-pulse LCI drive control

FIG. 3 shows a detailed block diagram of the intelligent monitoring system for a 12-pulse LCI drive used in mineral grinding applications.

### DETAILED DESCRIPTION OF THE PREFERRED EMBODIMENTS

To achieve a better description of the present invention an explanation of its functioning is given based on the monitoring of a 12-pulse LCI inverter.

12-Pulse LCI

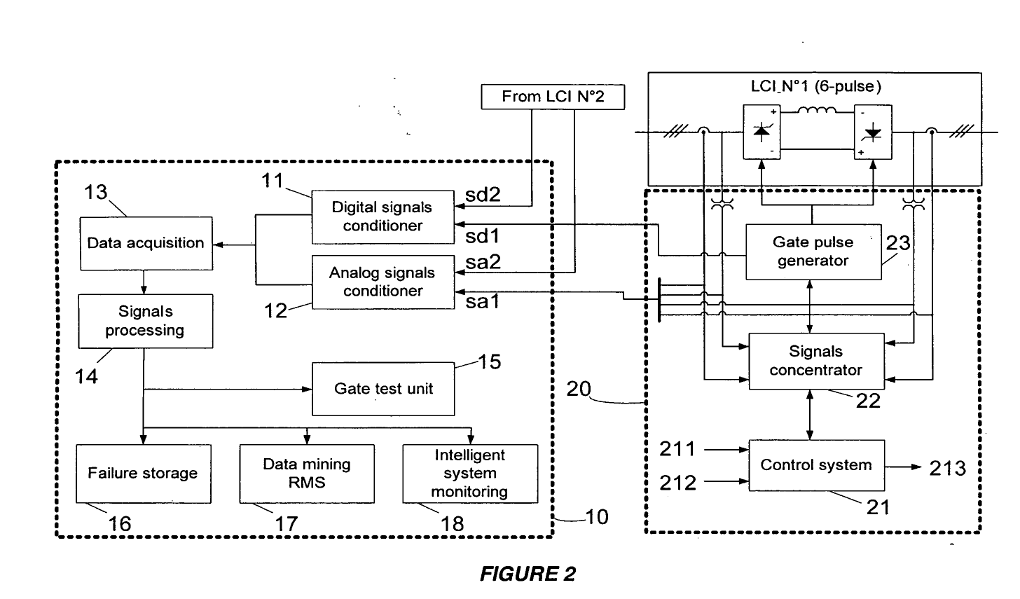

This drive (FIG. 2, background art) is made up of two 6-pulse LCI which are connected by two coupling transformer secondaries (wye-delta connection). Each 6-pulse LCI drive is composed by two bridge thyristors (6 Silicon Controlled Rectifier SCR semiconductors each) connected in anti-parallel manner by a continuous current link, which is stabilized by a reactor. The three-phase system connects to the T1 transformer primary, fed by its two secondaries to the two 6-pulse LCI. A synchronic motor is fed from the primary of the T2 transformer, whose secondaries are connected to the outputs of the two 6-pulse LCI.

Control System (20)

Each one of the two 6-pulse LCI has a control scheme (inherent to the drive) that basically consists of three steps (See FIG. 2):
a) Control System (21): performs control based on the reference speed of the motor (211) and the process signals (212), which are received from the master control system, which in turn delivers process signals (213).
b) Signal Distribution Module (22): Receives the electrical measurements from the two 6-pulse LCI, which in turn communicate with the control system (21). On the other side, the control system (21) sends firing-signals towards this module. Additionally this module delivers the firing-signals to each pulse amplifier module (23). The control system of the 12-pulse LCI drive described before depends on the manufacturer.
c) Firing-Pulse Amplification (23): modules (one for each semiconductor) that receive a logical firing signal and then amplify it applying an isolated current pulse in the gate of each semiconductor to incite their ignition. These modules can measure semiconductor conductivity as well as a signal that acknowledges the correct generation of a current pulse. Both signals are incorporated into the Intelligent Monitoring System (10).
   Intelligent Monitoring System (10)

In parallel to the control scheme, the intelligent monitoring system (10) receives analog measurements (sa1 and sa2) from the two 6-pulse LCI in addition to the digital signals (sd1 and sd2) from the pulse amplifier modules (2 signals per semiconductor). These signals go through an adjustment process in which the digital (11) and analog (12) signals pass through an adaptation phase compatible with acquisition system. Afterwards there is a data acquisition stage (13) and data processing (14) and finally, routines that execute the different monitoring and failure detection tasks. Each one of these stages generate: information that is displayed on a screen, temporary registers of electrical variables, failure registers, etc.

It is important to point out that the coupling between the intelligent monitoring system (10) and the control scheme (20) is performed in a totally non-invasive manner. This mitigates the effects that the disturbances of the intelligent monitoring system may cause on the drive operation and vice versa.

This intelligent monitoring system (10) for this particular case requires 32 analog and 48 digital signals that are provided by the control system of the 12-pulse LCI drive. Both analog and digital signals must be adapted for the following data acquisition. Once the information is acquired these are made available to the four main functions of the intelligent monitoring system, which are detailed next:

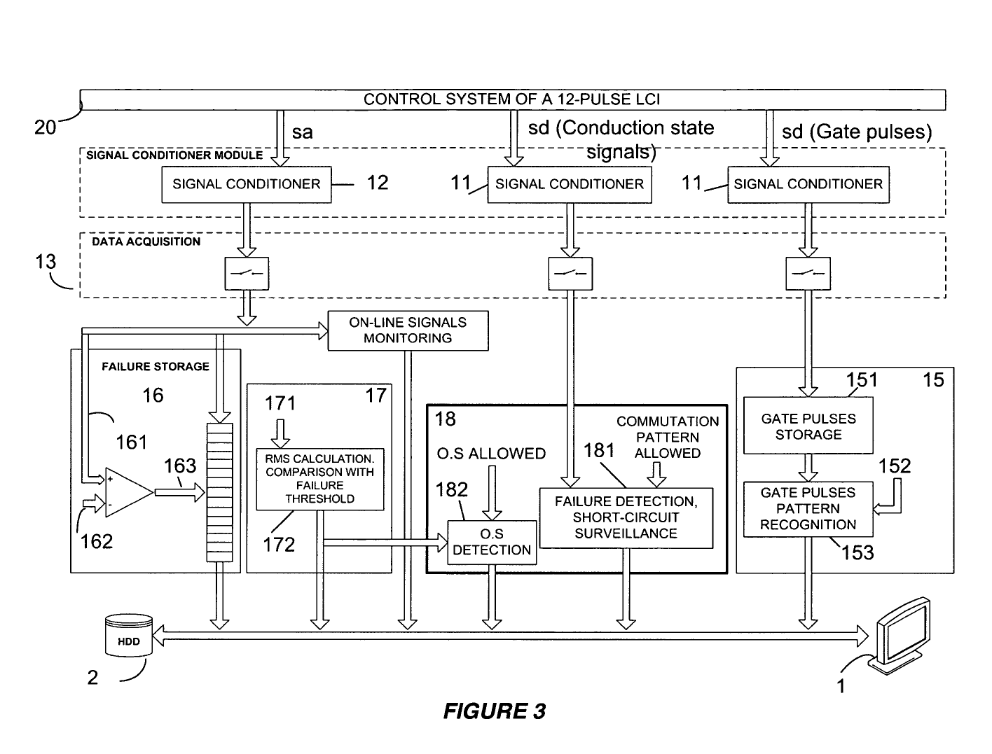

a) Failure Storage (16): See FIG. 3. This function performs the comparison among the measured value of a certain variable (161) and its location in a range of values that are considered normal (162). This value interval is generated by simulators or obtained by field measurements. This comparison is performed in the time domain, point to point, which allows adjusting the sensitivity of the detection of abnormal conditions. This comparison generates a trigger signal (163) that commands the circular buffer of a hard disk (2). The objective of this is to be able to access data during the interval when an abnormal condition appeared. Additionally this function displays on a screen (1) the monitored variables.

b) Data Mining (17): This function allows monitoring the analog variables of the system in RMS values (171). This requires processing the acquired signals to obtain their RMS values. Once this has been performed, these values are compared (172) to reference values. This allows storing data in normal operation conditions as well as abnormal operation conditions and during much more time due to the smaller amount of data registered per cycle. This function allows constructing a file of some drive variables of interest. These variables are stored with statistic purposes that may be employed additionally as a preventive indicator of some operational drive failure or mill failure. It is also possible to visualize these historic files on a display screen (1).

c) Intelligent Monitoring (18): this is the backbone of this invention since it establishes the difference with the rest of the existing alternatives in the market for monitoring grinding drives. Specifically this function detects the origin and location of certain types of failures such as problems with the semiconductor commutation, failures provoked by the deterioration of the semiconductors and firing circuits, and failures caused by disturbances in the electrical feed network. All of these previous situations cause a particular commutation pattern which is detected by the intelligent monitoring system. Additionally the intelligent monitoring system detects the overall drive operation state. To perform both tasks it is necessary to implement two subtasks, which are detailed next.
c.1) Short-Circuit (SC) Failure Detection (181): This module detects short-circuit in the 12-pulse LCI drive through real-time monitoring of the conduction state of the semiconductors, which are originated from the digital signals that represent those states. This function monitors, detects and identifies any uncharacteristic commutation of the drive that may cause a short-circuit and drive failure. Each kind of drive has a characteristic commutation pattern, thus when monitoring in real-time the conduction state of the semiconductors, it is possible to locate precisely the semiconductors that caused that failure.
c.2) Drive operation state (O.S) detection (182): Comparison between an operational state detected of the drive with an operational state condition considered as normal; speed reference of the mill must be similar to the motor speed measured, power developed by each 6-pulse LCI drive must be similar also, checking this two task the control loop of the mill can be easily verified and any commutation failure rejected which can provoke a power unbalance in the drive.

d) Gate Test (15): normally after a drive general maintenance it is necessary to test that it is functioning properly before it is placed in service again. Thus it is necessary to specifically check the firing pulses, the pulse amplifier modules and the semiconductors. In the specific case of the LCI it is normal to perform a Gate Test that consists of generating test fires to corroborate the correct functioning of the hardware and software associated to the power part of the system. This firing pattern is generated using a special control routine provided by the manufacturer, without having to place into service the drive. This manual corroboration procedure is considerably slow since it requires comparing a firing pattern considered normal with the measurements obtained with a portable device. A solution for this is to implement a procedure as part of the intelligent monitoring system with a module called Gate Test (15). The Gate Test module (15) allows testing all the semiconductors simultaneously and displays on a screen (1) the results required for an electronical comparison with a known pattern (background art). This block requires two sources of data. The first corresponds to a measurement performed on the firing pulses that control the semiconductors, which are available in the digital signals (sd) from the firing cards. These digital signals are stored for a convenient amount of time in the firing pattern storage block (151). Once stored, they need to be processed using a pattern comparison algorithm (153). This comparison is done contrasting to a known firing pulse pattern. If any electronic component should fail in the semiconductor process control, this system will identify the component that is presenting problems.

In addition to the four described functions, the display screen (1) and data storage in hard disks (2), or similar storage devices, exist.

What is claimed is:

1. Intelligent Monitoring System of 12-pulse LCI drive that controls the motors in charged of driving SAG and ball mills that are present in the mineral grinding process compromising: a drive short-circuit detection technique that compromises measuring conductivity state signals of each semiconductor of the 12-pulse LCI drive; a technique to determine the overall electrical drive operation state that compromises measuring voltage and current signals at different locations of interest in the mentioned drive.

2. The intelligent monitoring system of claim 1, wherein the technique compromises adapting the measured signals, acquiring the adapted signals, identifying the conduction pattern of the 12-pulse LCI drive, and comparing with correct commutation pattern.

3. The intelligent monitoring system of claim 2, wherein it additionally compromises generating a warning if a short-circuit occurs.

4. The intelligent monitoring system of claim 3, wherein it additionally compromises performing programmed actions if a short-circuit occurs.

5. The intelligent monitoring system of claim 1, wherein the module that determines the overall operation state of the 12-pulse LCI drive compromises the adapting the measured signals, calculating RMS values of the acquired signals, determining the operation state (O.S.) in which the drive finds itself, comparing the measured values with the operation intervals corresponding to the O.S.

6. The intelligent monitoring system of claim 5, wherein it additionally compromises generating an output report.

7. An intelligent monitoring method of a 12-pulse LCI drive that control the motors in charged of driving the SAG and ball mills present in the mineral grinding process, wherein the method compromises the following steps: detecting drive short-circuits in the 12-pulse LCI drive, measuring the conduction state of each semiconductor of the 12-pulse LCI drive; and also monitoring the overall operation state of 12-pulse LCI drive that compromises measuring voltage and current signals at different locations of interest in the mentioned drive.

8. The intelligent monitoring system of claim 7, wherein the short-circuit detection stage compromises adapting the measured signals; acquiring the adapted signals; identifying the conduction pattern of the 12-pulse LCI drive; and comparing with correct commutation logic of a 12-pulse LCI drive.

9. The intelligent monitoring system of claim 8, wherein it additionally compromises generating a warning if a short-circuit occurs.

10. The intelligent monitoring system of claim 9, wherein it additionally compromises performing programmed actions if a short-circuit occurs.

11. The intelligent monitoring system of claim 7, wherein the stage of monitoring the overall drive operation state of the 12-pulse LCI drive compromises adapting the measured signals; acquiring the adapted signals; calculating RMS values of the acquired signals; determine the operation state (O.S.) in which the drive finds itself; and comparing the measured values with the operation intervals corresponding to the O.S.

12. The intelligent monitoring system of claim 11, wherein it additionally compromises generating an output report.
